(19) United States
(12) Patent Application Publication
(10) Pub. No.: US 2025/0136418 A1
(43) Pub. Date: May 1, 2025

(54) Rotary Drive Device

(71) Applicant: Walter Föckersperger, Pauluszell/Ndb. (DE)

(72) Inventor: Daniel Föckersperger, Pauluszell/Ndb. (DE)

(21) Appl. No.: 18/690,204

(22) PCT Filed: Sep. 29, 2022
(86) PCT No.: PCT/EP2022/077105

§ 371 Date: Mar. 7, 2024

(30) Foreign Application Priority Data
Oct. 4, 2021 (DE) 20 2021 105 351.8

(51) Int. Cl. B66D 1/08; F01C 1/00; F01C 21/00; F16D 41/16

(52) U.S. Cl. CPC B66D 1/08; F01C 1/00; F01C 21/008; F16D 41/16

(57) ABSTRACT

The invention relates to a rotary drive for a drum in a winch on a support frame, which has a fluid-operated rotary piston motor that has a housing and a shaft. There are reversible freewheel couplings in a force-transfer path between the motor housing and the support frame and in a force-transfer path between the motor housing and the drum with which the motor housing can be connected to the support frame and the drum for transfer of forces. There are reversible freewheel couplings in a force-transfer path between the shaft and the support frame and in a force-transfer path between the shaft and the drum with which the shaft can be connected to the support frame and the drum for transfer of forces.

### BACKGROUND OF THE INVENTION

### Field of the Invention

The present invention relates to a rotary drive device, in particular a winch drive for a drum, in particular for a winch in a support frame.

### Description of Related Art

These winches are used to tow heavy agricultural machinery, e.g. pipe-and-cable-laying plows, with which flexible cables, e.g. electrical cables, lightning protection cables, barrier tapes, cover bands, pipes, etc. are placed in the ground. WO 03/053821 A1 discloses a mobile winch assembly that contains a winch, a drum supported on an axle onto which a cable is wound, and a support frame for the drum axle. The support frame is attached to carriage of a tractor, such that the winch is supported by the frame on the carriage. The drive in the form of an electric or hydraulic motor is located in the drum, and there is a coupling between the drive and the drum.

Although the winch assembly in WO 03/053821 A1 can be used for relatively heavy loads of up to 80 tons, and large torques can be obtained, there is room for improvement with regard to accommodating heavier loads and greater torques at lower rotational rates.

### SUMMARY

Based on WO 03/053821 A1, the object of the invention is to therefore to create a rotary drive that can accommodate heavier loads and torques at lower rotational rates.

This problem is solved by a rotary drive according to claim 1. Advantageous developments of the invention are the subject matter of the dependent claims 2 to 14.

The rotary drive according to the invention, in particular in the form of a winch drive for a drum, in particular a winch in a support frame, is distinguished by a rotary piston motor that can be operated with a fluid, which has a housing and a shaft. There is a reversible freewheel coupling for transferring forces between the housing and the support frame, and between the housing and drum, with which the housing can be connected to the support frame or the drum. There is a reversible freewheel coupling for transferring forces between the shaft and the support frame, and between the shaft and the drum, with which the second shaft can be connected to the support frame or the drum.

In a preferred embodiment, the rotary piston motor, which can also be referred to as a rotary vane motor, is a hydraulic motor. In an alternative embodiment, a fluid motor, e.g. a pneumatic motor, can be used instead of the hydraulic motor. The shaft passes through the rotary piston motor housing. Diametrically opposed first pistons are connected to the housing for conjoint rotation, and diametrically opposed second pistons are connected to the shaft for conjoint rotation. The first and second pistons alternate around the shaft, such that a sealed pressure chamber is formed between each first piston and each second piston. Both the first pistons and the second pistons have an arc segment cross section when viewed along the rotational axis of the shaft. When hydraulic fluid (or some other fluid such as pressurized air) enters the pressure chamber, the first pistons can bear against the second pistons such that they rotate about the shaft. This requires that rotation of the second pistons connected to the shaft for conjoint rotation is prevented by a freewheel coupling at the support frame side, or rotation of the first pistons, which are connected to the housing for conjoint rotation, is prevented by a freewheel coupling on the support frame side. In other words, a force transferring path from the support frame to the drum is obtained with one of the two freewheel couplings on the support frame, the shaft, or the motor housing, and one of the two freewheel couplings on the drum. Consequently, the drum in the rotary drive can be caused to rotate, such that a hauling cable attached to a pipe-and-cable-laying plow can be wound up or wound out from it.

When the first pistons bear on the second pistons, because hydraulic fluid is fed into the pressure chamber behind the first pistons in the movement path, the first pistons can only rotate, or pivot, until they come in contact with the second pistons that are in front of them in the movement path. The rotary drive for the drum can stop moving briefly. Hydraulic fluid can subsequently be fed into the pressure chamber behind the second pistons in the movement path, such that the second pistons bear on the first pistons. The second pistons can then only rotate, or pivot, until they come in contact with the first pistons that are in front of them. These steps can be repeated as often as necessary, until the hauling cable is fully wound onto the drum. The positions of the first and second pistons are monitored by rotary sensors, for example. Hydraulic valves that regulate the supply of hydraulic fluid to and from the pressure chambers are controlled by a programable logic controller (PLC) such that either the first pistons bear on the second pistons, or vice versa.

The freewheel couplings according to the invention are reversible, i.e. they can prevent rotation of the housing or the shaft in either direction, and allow rotation in the other direction. This is necessary in order to allow torque to be applied to the drum in both directions. In a fully disengaged (middle) setting of the freewheel coupling, the housing and shaft can rotate in both directions, and no force is transferred between the housing or the shaft and the support frame or the drum. The freewheel couplings can remain in their settings the entire time that the hauling cable is being wound onto the drum. In each case, one of the freewheel couplings on the support frame and on the drum transfers the force generated by the first and second pistons, and the other freewheel couplings on the support frame and the drum are fully disengaged and transfer no forces.

The rotary drive according to the invention is designed to support heavy loads and maintain torques for long periods at low rotational rates. The rotary drive according to the invention applies high torques at low rotational rates without additional gearing.

The freewheel couplings on the support frame, and the freewheel couplings on the drum can be on different sides of the rotary piston motor. This results in a symmetrical, compact structure for the rotary drive.

The freewheel couplings on the drum can be fully disengaged, such that the force-transfer path to the drum is interrupted. This fully disengaged setting of the freewheel couplings can be used when there is no more tension on the hauling cable, after it has been wound onto the drum.

The freewheel couplings on the support frame can be fully disengaged, such that the force-transfer path to the support frame is interrupted. This fully disengaged setting of the freewheel couplings can be used when there is no more tension on the hauling cable, after it has been wound onto the drum.

The freewheel couplings on the support frame can be accommodated in a housing on the support frame, which is connected to the support frame for conjoint rotation, and the freewheel couplings on the drum can be accommodated in a housing on the drum, which is connected to the drum for conjoint rotation. Consequently, there only needs to be one connection between the housing for the couplings on the support frame and the support frame, and between the housing for the couplings on the drum and the drum.

Each of the freewheel couplings can have its own coupling rotor, which can be connected to the respective housings by coupling elements. The coupling rotors in each of the freewheel couplings can be connected to either the shaft or the housing for the motor for conjoint rotation. The coupling elements can be switched synchronously.

The freewheel couplings can have pawls. The coupling elements are the pawls In this case. The pawls can bear on teeth formed on the coupling housings, to prevent rotation of the shafts in either direction. Other elements can also be used, instead of pawls, with which the force transfer path can be obtained or interrupted between the shafts and the support frame. It is only important that the elements are reversible, such that torques can be transferred in both directions to the drum.

The freewheel couplings can be switched from one setting to another by a fluid. It is also fundamentally possible for the freewheel couplings to be switched mechanically, pneumatically, or electromagnetically, etc. Fluid switching has the advantage that the fluid can be supplied by the same fluid circuit that is used for the hydraulic rotary piston motors.

The rotary drive can contain a fluid circuit with valve dedicated to the at least one rotary piston motor and the freewheel couplings that control the amount of fluid supplied thereto.

The rotary drive can contain an electronic control unit for the valve in the fluid circuit. This electronic control unit is preferably a programmable logic controller (PLC).

The electronic control unit can contain position sensors, e.g. rotation sensors, for detecting the rotational angle of the shaft in relation to the housing for the rotary piston motor. The positions of the first and second pistons can be detected by this means, such that the operation of the rotary drive can be easily monitored.

The rotary drive can contain a second rotary piston motor operated with a fluid, which contains a second motor housing and a second shaft, in which there are reversible freewheel couplings for transferring forces between the second housing and the support frame, and between the second housing and drum, with which the second housing can be connected to the support frame or the drum, and reversible freewheel couplings between the second shaft and the support frame, and between the second shaft and the drum, with which the second shaft can be connected to the support frame or the drum.

The torque applied to the drum can be doubled by the second rotary piston motor. The rotary drive can also run significantly more smoothly when both rotary piston motors are synchronized such that the times when rotation, or pivotal movement, changes from the first piston to the second piston, or from the second piston to the first piston, are asynchronous. In other words, it can be ensured that the rotary drive for the drum is never at rest.

The drum can be a tube in the rotary drive according to the invention, and the rotary piston motor or motors can be placed inside the drum. This saves a lot of space, in particular when the freewheel couplings are inside the drum tube. The coupling housing can have a round exterior, such that they can be easily attached to the inside of the drum tube. The torque can then be easily applied to the drum tube by the housing for the couplings in the drum, without additional gearing.

### BRIEF DESCRIPTION OF THE DRAWINGS

Preferred embodiments of the rotary drive according to the invention shall be explained below in reference to the drawings, in which

FIG. 1 shows a sectional view cut along a drum axis for a rotary drive according to the invention;

FIG. 2 shows front, sectional views looking along the arrows A-A, B-B, C-C, D-D and E-E in FIG. 1, at a first point in time, when the drum is rotating in the clockwise direction;

FIG. 3 shows front, sectional views looking along the arrows A-A, B-B, C-C, D-D and E-E in FIG. 1 at a second point in time, when the drum is rotating in the clockwise direction;

FIG. 4 shows front, sectional views looking along the arrows A-A, B-B, C-C, D-D and E-E in FIG. 1 at a point in time, when the drum is rotating in the counterclockwise direction; and

FIG. 5 shows a sectional view cut along a drum axis in the rotary drive according to the invention.

### DETAILED DESCRIPTION

### Structure of the Rotary Drive 1

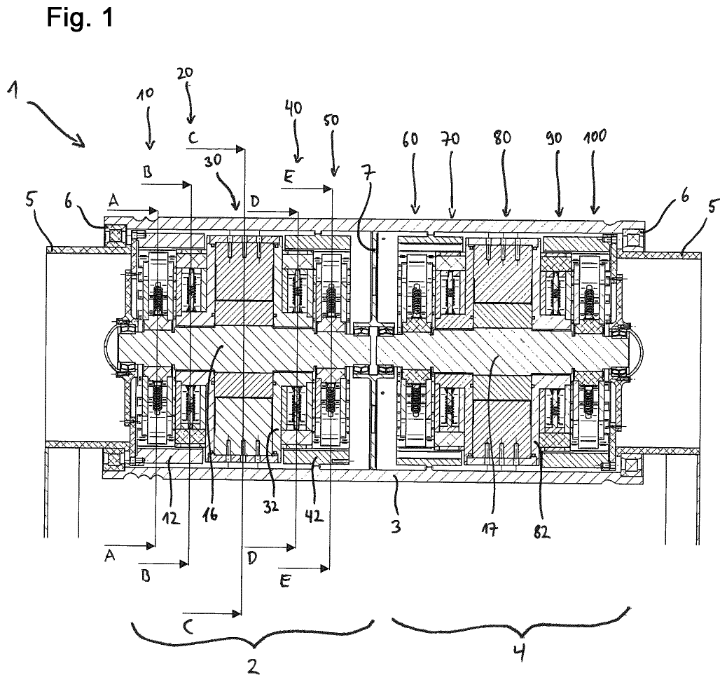

FIG. 1 shows a rotary drive 1 for a tube drum 3 in a winch on a support frame 5. The support frame 5 is mounted on the carriage of a tractor, not shown in the drawings. A hauling cable can be wound onto and wound out from the drum 3, to which a pipe-and-cable-laying plow, for example, is attached, with which a flexible material, e.g. power cables, lightning protection cables, barrier tapes, cover bands, pipes, etc. can be placed in the ground. The drum 3 is supported on the frame 5 by cylindrical roller bearings 6 in this embodiment.

The rotary drive 1 has two independent, parallel rotary piston motors, a first rotary piston motor 30 and a second rotary piston motor 80, which are substantially identical. The rotary piston motor 30 is part of a drive system 2, which also contains a shaft 16, two freewheel couplings 10, 20 on the support frame side, and two freewheel couplings 40, 50 on the drum side, each pair of which are accommodated in a single housing, 12 and 42, respectively. The first housing 12 is connected to the support frame for conjoint rotation, and the second housing is connected to the drum 3 for conjoint rotation. The second rotary piston motor 80 is part of a second drive system 4, which also has two freewheel couplings 90, 100 on the support frame side, two freewheel couplings 60, 70 on the drum side, and a shaft 17. The two drive systems function identically, for which reason only the first drive system 2 shall be described below.

The rotary piston motor 30 is a hydraulic motor, which is operated with hydraulic fluid from a fluid circuit not shown in the drawings. The rotary piston motor 30 has a housing 32, which is connected to the freewheel coupling 20 on the support frame side and the freewheel coupling 40 on the drum side for conjoint rotation, and can form a part of the force-transfer path between the support frame 5 and the drum 3. The shaft 16 passes through the rotary piston motor 30 and the freewheel couplings 10, 20, 40, 50, and is supported on the frame 5 by double cylinder roller bearings, and a bearing segment 7 in the drum 3. The shaft 16 is connected to the freewheel coupling 10 on the support frame side and the freewheel coupling 50 on the drum side for conjoint rotation, and can form a part of a force-transfer path between the support frame 5 and the drum 3.

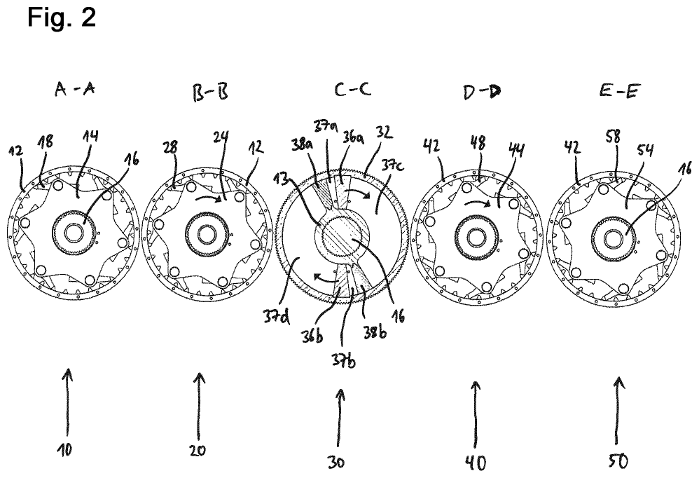

FIG. 2 shows front views of the freewheel couplings 10, 20 on the support frame side, and freewheel couplings 40, 50 on the drum side, looking along the arrows A-A, B-B, D-D, and E-E in FIG. 1. The freewheel couplings 10, 20, 40, 50 each have a star-shaped coupling rotor 14, 24, 44, 54. The coupling rotors 14, 54 are connected by a spline to the shaft 16 for conjoint rotation. The coupling rotors 24, 44 are connected by a spline to the motor housing 32 for conjoint rotation. Reversible coupling elements formed by pawls 18, 28, 48, 58 are attached to the coupling rotors 14, 24, 44, 54, which can be switched synchronously by a switching wheel between three settings. In the first setting shown in FIG. 2, the pawls 18, 28 bear at one end on teeth formed on an inner circumference of the coupling housing 12. Counterclockwise rotation of the coupling rotors 14, 24 and the motor housing 32 and shaft 16 is blocked in the first setting. Clockwise rotation of the coupling rotors 14, 24, motor housing 32 and shaft 16 is possible. The pawls 48, 58 are in a second setting in FIG. 2 (see section D-D and E-E) and bear at their other ends on the teeth formed on the inner circumference of the coupling housing 42. Clockwise rotation of the coupling rotors 44, 54 is blocked in the second setting. Torque can be applied to the drum 3 through the connection of the coupling housing 42 to the drum for conjoint rotation. The pawls 18, 28, 48, 58 are fully released in the third setting, in which neither ends bear on the teeth in the respective coupling housings 12, 42. The coupling rotors 14, 24, 44, 54 can rotate freely in both the clockwise and counterclockwise direction in this third setting. The pawls in the freewheel couplings can be switched synchronously, independently of one another to any of the three settings, and can produce or interrupt a force-transferring connection between the support frame 5 and the drum 3. Switching between the settings of the pawls 18, 28, 48, 58 is obtained with a fluid, or hydraulic fluid. A fluid circuit, not shown in the drawings, is electronically controlled for this by a programmable logic controller (PLC).

FIG. 2 also shows a sectional view of the rotary piston motor 30 looking along the arrow C-C in FIG. 1. The rotary piston motor 30 has two diametrically opposed first pistons 36a, 36b, which are connected to the motor housing 32 for conjoint rotation, and two diametrically opposed second pistons 38a, 38b, which are connected by a ring 13 with inner teeth to the shaft 16 for conjoint rotation. The first pistons 36a, 36b, motor housing 32, second pistons 38a, 38b, and the ring 13 are separate components in this embodiment. The first pistons 36a, 36b and motor housing 32, and/or the second pistons 38a, 38b and ring 13 can also be formed as integral components. Both the first pistons 36a, 36b and second pistons 38a, 38b have arc segment cross sections seen along the rotational axis of the shaft 16. There are pressure chambers 37a to 37d between the first and second pistons, into and from which hydraulic fluid can be fed and drained by means of the hydraulic valve in the fluid circuit controlled by the PLC.

### Functioning of the Rotary Drive 1

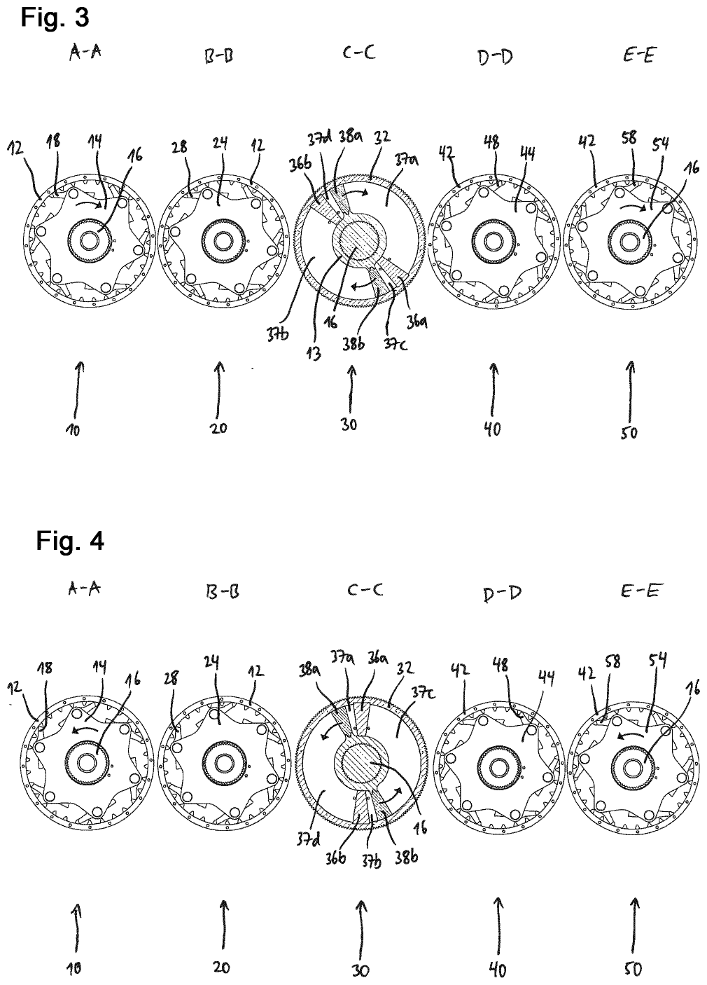

The functioning of a preferred embodiment of the rotary drive 1 according to the invention shall be described below in reference to FIGS. 2 and 3.

The description of the functioning starts with hauling cable that has been wound out, to which the pipe-and-cable-laying plow is attached, but not pulled tight. The tractor pulls the pipe-and-cable-laying plow toward it. This corresponds to a clockwise rotation of the motor housing 32, the first pistons 36a, 36b, the second pistons 38a, 38b, and the drum 3 in FIGS. 2 and 3. Before the rotary drive can initiate clockwise rotation, the pawls 18, 28 bear on the teeth in the coupling housing 12 in the counterclockwise direction, and the pawls 48, 58 bear on the teeth in the coupling housing 42 in the clockwise direction, as shown in FIG. 2.

Hydraulic fluid is subsequently fed into the pressure chamber 37a between the first piston 36a and second piston 38a and the pressure chamber 37b between the first piston 36b second piston 38b at a high pressure of up to 350 bar. Because counterclockwise rotation of the second pistons 38a, 38b and the shaft 16 is prevented by the freewheel coupling 10, the first pistons 36a, 36b can bear on the second pistons 38a,38b, and rotate in clockwise direction, as indicated by the arrows in FIG. 2. In this first torque phase, the first pistons 36a, 36b function as working pistons and the second pistons 38a, 38b function as support pistons. Because the motor housing 32 is connected for conjoint rotation to the coupling rotor 24, the coupling rotor 24 rotates freely with the disengaged pawls 28. Because the motor housing 32 is connected for conjoint rotation with the coupling rotor 44, the coupling rotor 44 rotates freely with the pawls 48 in the clockwise direction, and transfers the torque generated thereby to the coupling housing 42 and the drum 3, which rotates in the clockwise direction, such that the hauling cable can be wound up. While hydraulic fluid is fed into the pressure chambers 37a and 37b, hydraulic oil is drained from the pressure chambers 37c and 37d.

The first pistons 36a, 36b can only pivot, or rotate, until the first piston 36a bears on the second piston 38b, and the first piston 36b bears on the second piston 38a. The first pistons 36a, 36b stop pivoting, or rotating, and the drive system 2 comes to a stop briefly. Hydraulic fluid is subsequently fed into the pressure chambers 37c and 37d. Because the freewheel coupling 20 prevents counterclockwise rotation of the first pistons 36a and 36b, and the shaft 16, the second pistons 38a, 38b can bear on the first pistons 36a, 36b, and rotate in the clockwise direction, as indicated by the arrows in FIG. 3. The second pistons 38a, 38b function as working pistons and the first pistons 36a, 36b function as support pistons in this second torque phase. Because the shaft 16 is connected to the coupling rotor 14 for conjoint rotation, the coupling rotor 14 rotates freely with the disengaged pawls 18 in the clockwise direction. Because the shaft 16 is connected to the coupling rotor 54 for conjoint rotation, the coupling rotor 54 rotates freely with the pawls 58 in the clockwise direction and transfers the torque generated thereby to the coupling housing 42 and the drum 3, which rotates in the clockwise direction, and can continue to wind up the hauling cable. While hydraulic fluid is fed into the pressure chambers 37c and 37d, hydraulic fluid is drained from the pressure chambers 37a and 37b.

The steps described above can be repeated as often as necessary, until the hauling cable is fully wound onto the drum 3. The torque M generated by the rotary piston motor 30 during the torque application phase can be calculated with the formula

$$M = 2 * p * A * l$$

in which p is the pressure of the hydraulic fluid in the pressure chambers, A is the surface area of the piston, and l describes a perpendicular lever arm from the rotational axis of the shaft 16 to a center of gravity of the respective piston surface. The pressure p of the hydraulic fluid in the pressure chambers can be detected by pressure sensor, not shown in the drawings. The positions of all of the pairs of pistons in the rotary piston motor 30 during operation are monitored by rotary sensors.

The brief period in which the drive system 2 is at a standstill, and the brief interruption in the rotation of the drum 3 caused by this, can be compensated for by the drive system 4. In particular, at the point in time in which the rotation, or pivotal movement, of first pistons 36a, 36b switches to the second pistons 38a, 38b, and the point in time in which the rotation, or pivotal movement, of the second pistons 38a, 38b switches to the first pistons 36a, 36b, can be asynchronous to the corresponding points in time in the second rotary piston motor 80. The programed PLC ensures this by controlling the hydraulic valves in all of the pressure chambers.

It is also possible to rotate the drum 3 in the counterclockwise direction with the rotary drive 1 according to the invention. To generate a continuous counterclockwise rotation, the sequence of steps described above remains substantially the same. Only the positions of the paws 18, 28, 48, 58 are reversed, as shown in FIG. 4.

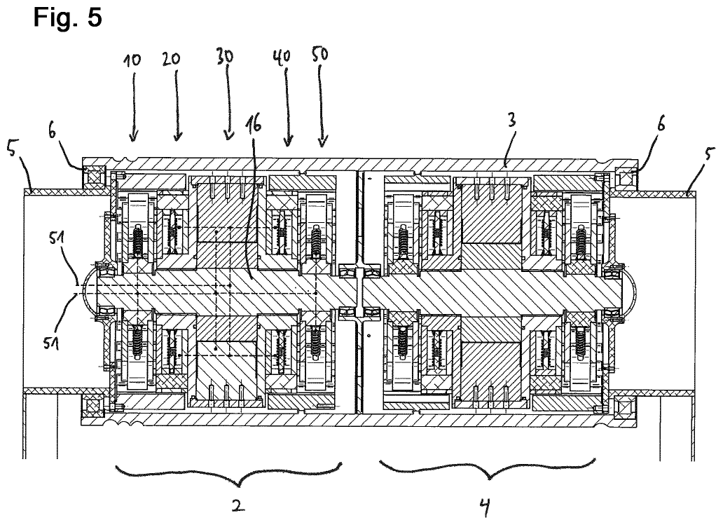

The hydraulic fluid lines 51 in the fluid circuits for the pressure chambers 37a to 37d in the rotary piston motor 30 and the freewheel couplings 10, 20, 40, 50 are indicated by broken lines in FIG. 5. As can be seen in FIG. 5, the hydraulic fluid lines 51 lead from outside the drum 3 through the shaft 16 to the pressure chambers 37a to 37d and the freewheel couplings 10, 20, 40, 50.

1. A rotary drive, in particular a winch drive, for a drum, in particular supported on a frame, the drive comprising:
a fluid-operated rotary piston motor that has a housing and a shaft, wherein,
reversible freewheel couplings are in a force-transfer path between the motor housing and the support frame, and a force-transfer path between the motor housing and the drum, with which the motor housing can be connected for a transfer of force to the support frame or the drum, and
reversible freewheel couplings are in a force-transfer path between the shaft and the support frame, and a force-transfer path between the shaft and the drum, and wherein the shaft can be connected for a transfer of force to the support frame or the drum.

2. The rotary drive according to claim 1, wherein the freewheel couplings at the support frame sides, and the freewheel couplings at the drum sides are on opposite sides of the rotary piston motor.

3. The rotary drive according to claim 1, wherein the freewheel couplings at the drum side can be fully disengaged, such that the force-transfer path to the drum is interrupted.

4. The rotary drive according to claim 1, wherein the freewheel couplings at the support frame side can be fully disengaged, such that the force-transfer path to the support frame is interrupted.

5. The rotary drive according to claim 1, wherein
the freewheel couplings at the support frame side are in a single housing, which is connected to the support frame for conjoint rotation, and
the freewheel couplings at the drum side are in a single housing, which is connected to the drum for conjoint rotation.

6. The rotary drive according to claim 5, wherein the freewheel couplings each have a coupling rotor, which can be connected to the respective coupling housings for force transfer by reversible coupling elements.

7. The rotary drive according to claim 1, wherein the freewheel couplings are pawl freewheel couplings.

8. The rotary drive according to claim 1, wherein the freewheel couplings can be switched with a fluid.

9. The rotary drive according to claim 8, further comprising a fluid circuit that contains valves dedicated to the at least one rotary piston motor and the freewheel couplings for controlling the fluid supply to the rotary piston motor and the freewheel couplings.

10. The rotary drive according to claim 9, further comprising an electronic control unit for controlling the valves in the fluid circuit.

11. The rotary drive according to claim 10, wherein the electronic control unit contains position sensors for detecting the rotational angular position of the shaft in relation to the motor housing for the rotary piston motor.

12. The rotary drive according to claim 1, further comprising:
a fluid-operated second rotary piston motor, which has a second housing and a second shaft, wherein
there are reversible freewheel couplings in a force-transfer path between the second motor housing and the support frame, and a force-transfer path between the second motor housing and the drum, with which the second motor housing can be connected for a transfer of force to the support frame and the drum, and
there are reversible freewheel couplings in a force-transfer path between the second shaft and the support frame, and a force-transfer path between the second shaft and the drum, with which the second shaft can be connected for a transfer of force to the support frame and the drum.

13. The rotary drive according to claim 1, wherein:
the drum is a drum tube, and
the rotary piston motor is inside the drum tube.

14. The rotary drive according to claim 12, wherein:
the drum is a drum tube, and
the rotary piston motor and the second rotary piston motor are inside the drum tube.
